(19) United States
(12) Patent Application Publication
(10) Pub. No.: US 2015/0002739 A1
(43) Pub. Date: Jan. 1, 2015

(54) IMAGE DISPLAY SYSTEM AND IMAGE PROCESSING METHOD CAPABLE OF SUPPORTING UHD VIDEO/IMAGE DATA DISPLAY

(71) Applicant: TPV Display Technology (Xiamen) Co., Ltd., Xiamen Torch Hi-Tech Indust'l Dev. (CN)

(72) Inventor: Ming-Zhao RUI, Xiamen Torch Hi-Tech Indust'l Dev. Zone (CN)

(21) Appl. No.: 14/317,540

(22) Filed: Jun. 27, 2014

(30) Foreign Application Priority Data
Jun. 28, 2013 (CN) 201310269006.4

(51) Int. Cl. H04N 7/01; H04N 7/015

(52) U.S. Cl. CPC H04N 7/0125; H04N 7/015
USPC 348/441

(57) ABSTRACT

Disclosed are an image display system and an image processing method in which an image processing device conducts division of one frame data of an external digital image signal to obtain a plurality of sub-frame data, then converts the plurality of sub-frame data respectively into a plurality of LVDS video signals, and successively transmits the LVDS video signals to a display device in accordance with a switching signal and a synchronization signal. Upon receipt of the LVDS video signal, the display device processes the LVDS video signals so as to generate a display image signal, which corresponds to the frame data and is displayed thereon.

### CROSS-REFERENCE TO RELATED APPLICATION

This application claims priority of Chinese Application No. 201310269006.4, filed on Jun. 28, 2013, the contents of which are hereby incorporated by reference.

### BACKGROUND OF THE INVENTION

1. Field of the Invention

The invention relates to video/image processing, and more particularly to an image display system and an image processing method capable of supporting ultra high-definition video/image data display.

2. Description of the Related Art

The development of TVs and monitors has a current trend toward large size and high definition, and large-size and high-definition inevitably require higher resolution display generated from higher-resolution video/image data, which may be sent to a liquid crystal display (LCD) device over a greater transmission bandwidth and other support resources. However, although the video/image resolution has greatly increased, the image processing capacity of currently existing image processing devices has not caught up.

A resolution of full high-definition (FHD) is 1920×1080. A resolution of ultra HD (UHD) is 3840×2160 (also called 4K2K). Another resolution of ultra HD (UHD) is 7680×4320 (also called 8K4K). For currently existing low-voltage differential signaling (LVDS) interfaces, two transmission line groups may support transmission of FHD video/image data with a frame rate of 60 Hz; and four transmission line groups may support transmission of FHD video/image data with a frame rate of 120 Hz. Four times the transmission bandwidth for FHD LVDS video signals with a 30 Hz frame rate may be required to transmit 4K2K LVDS video signals with a 30 Hz frame rate. Eight times the transmission bandwidth for FHD LVDS video signals with a 30 Hz frame rate may be required to transmit 4K2K LVDS video signals with a 60 Hz frame rate. Sixteen times the bandwidth for FHD LVDS video signals with a 30 Hz frame rate may be required to transmit 4K2K LVDS video signals with a 120 Hz frame rate.

For example, in an LVDS interface for transmission of a 1024-grayscale image, each transmission line group includes five differential pairs of data transmission lines and one differential pair of clock transmission lines, i.e., each transmission line group consists of six pairs of transmission lines. In this case, in order to provide adequate data bandwidth, twelve pairs of transmission lines may be required to transmit FHD video/image data with a 60 Hz frame rate; twenty-four pairs of transmission lines may be required to transmit FHD video/image data with a 120 Hz frame rate or 4K2K LVDS video signals with a 30 Hz frame rate; and forty-eight pairs of transmission lines may be required to transmit 4K2K LVDS video signals with a 60 Hz frame rate. As a result, the number of the transmission lines of an LVDS interface may increase with increase of resolution and/or frame rate of video/image data to be transmitted. Such LVDS interface with a large number of transmission lines has higher cost and electrical connection with the large number of transmission lines is more difficult.

Therefore, in order to transmit UHD video/image data by using currently existing FHD transmission interfaces with transmission bandwidth for FHD LVDS video signals, a novel image processing method and a novel image display system capable of supporting UHD video/image data display are highly required.

### SUMMARY OF THE INVENTION

Therefore, an object of the present invention is to provide an image display system and an image processing method that can support UHD video/image data display and that can overcome the aforesaid drawbacks of the prior art.

According to one aspect of the present invention, an image display system comprises a display device and an image processing device. The image processing device includes a video processing unit and an output module. The video processing unit is configured to receive an external digital image signal, which includes at least one image frame. The video processing unit includes a video decoding module, a video adjusting module and a video encoding module. The video decoding module decodes the digital image signal to obtain one frame data of the digital image signal that corresponds to the image frame. The video adjusting module conducts division of the frame data to obtain a plurality of sub-frame data, each of which corresponds to a respective portion of the image frame. The video encoding module encodes the plurality of sub-frame data respectively into a plurality of low-voltage differential signaling (LVDS) video signals. The output module is coupled to the video processing unit and the display device, and successively transmits the LVDS video signals from the video processing unit to the display device in accordance with a switching signal and a synchronization signal, so that each of the LVDS video signals is transmitted within a cycle period of the synchronization signal and so that all the LVDS video signals are transmitted within a cycle period of the switching signal.

The display device receives the LVDS video signals from the output module of the image processing device in accordance with the switching signal and the synchronization signal, and processes the LVDS video signals so as to generate a display image signal, which corresponds to the frame data and is displayed thereon.

According to another aspect of the present invention, an image processing method comprises the steps of:

a) upon receipt of an external digital image signal including at least one image frame, decoding, by an image processing device, the digital image signal to obtain one frame data of the digital image signal that corresponds to the image frame;

b) conducting, by the image processing device, division of the frame data to obtain a plurality of sub-frame data, each of which corresponds to a respective portion of the image frame;

c) encoding, by the image processing device, the plurality of sub-frame data respectively into a plurality of low-voltage differential signaling (LVDS) video signals; and

d) successively transmitting, by the image processing device, the LVDS video signals to a display device in accordance with a switching signal and a synchronization signal; and

e) upon receipt of the LVDS video signals in accordance with the switching signal and the synchronization signal, by a display device, processing the LVDS video signals so as to generate a display image signal corresponding to the frame data, and displaying the display image signal.

### BRIEF DESCRIPTION OF THE DRAWINGS

Other features and advantages of the present invention will become apparent in the following detailed description of the preferred embodiments with reference to the accompanying drawings, of which:

FIG. 1 is a block diagram illustrating the preferred embodiment of an image display system according to the present invention;

FIG. 2 is a flow chart illustrating the preferred embodiment of an image processing method according to the present invention;

FIG. 3 shows an exemplary procedure illustrating how one frame data of a digital image signal is processed according to a first embodiment of this invention;

FIG. 4 illustrates the relationships among the frame data, sub-frame data, a switching signal (L/R) and a synchronization signal (Vsync) according to the first embodiment of this invention;

FIG. 5 shows another exemplary procedure illustrating how one frame data of a digital image signal is processed according to a second embodiment of this invention;

FIG. 6 illustrates the relationships among the frame data, sub-frame data, a switching signal (L/R) and a synchronization signal (Vsync) according to the second embodiment of this invention;

FIG. 7 is a further exemplary procedure illustrating how one frame data of a digital image signal is processed according to a third embodiment of this invention; and

FIG. 8 illustrates the relationships among the frame data, sub-frame data, a switching signal (L/R) and a synchronization signal (Vsync) according to the third embodiment of this invention.

### DETAILED DESCRIPTION OF THE PREFERRED EMBODIMENTS

Before the present invention is described in greater detail, it should be noted that like elements are denoted by the same reference numerals throughout the disclosure.

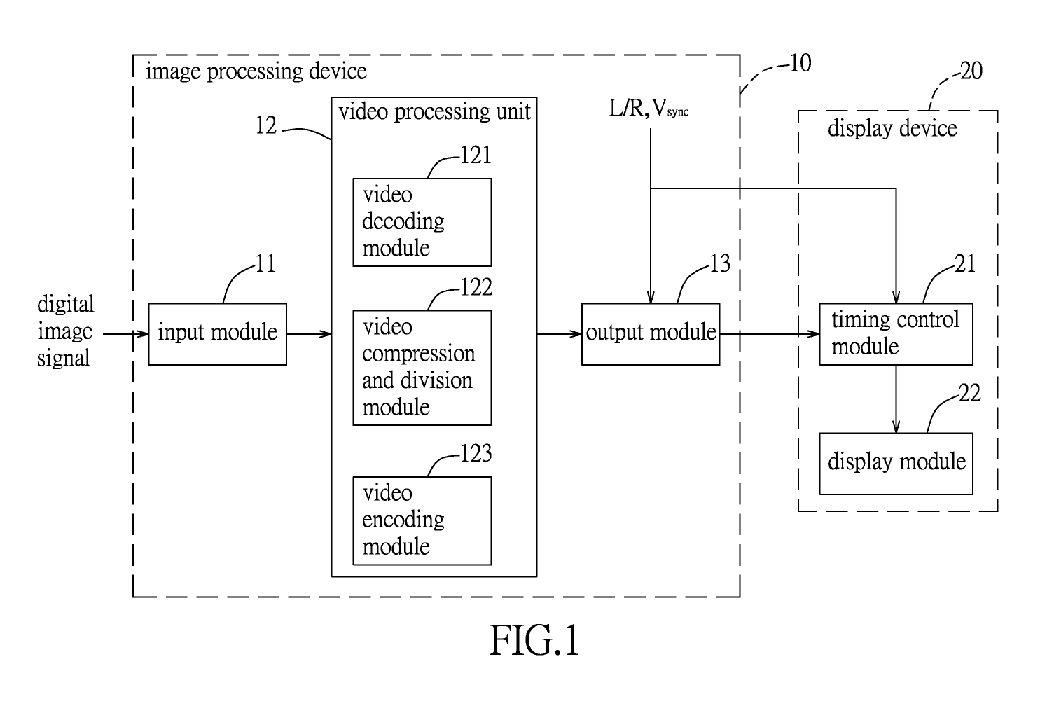

Referring to FIG. 1, the preferred embodiment of an image display system according to the present invention is shown to include an image processing device 10 and a display device 20.

The image processing device 10 includes an input module 11, a video processing unit 12 coupled to the input module 11, and an output module 13 coupled to the video processing unit 12. In this embodiment, the input module 11 may include a transmission interface (not shown), which may be one of a high-definition multimedia interface (HDMI), a display port (DP) interface, a digital interface for audio and video (DiiVA) and a thunderbolt interface. The input module 11 is used to transmit an external digital image signal to be processed to the video processing unit 12. In this embodiment, the digital image signal includes at least one image frame.

The video processing unit 12 includes a video decoding module 121, a video compression and division module 122 (i.e., a video adjusting module), and a video encoding module 123. It should be noted that each of the video decoding module 121, the video compression and division module 122 and the video encoding module 123 may be a software module, a hardware module or a combination thereof.

The video decoding module 121 decodes the digital image signal to obtain one frame data of the digital image signal that corresponds to the image frame. In this embodiment, the frame data may be UHD image data, for example, frame data with 3840×2160 (4K2K) or higher resolution.

The video compression and division module 122 compresses and divides the frame data into a plurality of sub-frame data, each of which corresponds to a respective portion of the image frame. It should be noted that the video compression and division module 122 may first compress the frame data along at least one of a vertical direction and a horizontal direction, and then divide the compressed frame data into the plurality of sub-frame data. Alternately, the video compression and division module 122 may first divide the frame data into a plurality of data blocks, and then compress the plurality of data blocks along at least one of the vertical direction and the horizontal direction respectively into the plurality of sub-frame data. In this embodiment, each sub-frame data may be FHD image data, i.e., image data with 1920×1080 (2K1K) resolution.

The video encoding module 123 encodes the plurality of sub-frame data respectively into a plurality of low-voltage differential signaling (LVDS) video signals. The output module 13 successively transmits the LVDS video signals corresponding respectively to the plurality of sub-frame data to the display device 20 in accordance with a switching signal (L/R) and a synchronization signal (Vsync), so that each of the LVDS video signals is received within a cycle period of the synchronization signal (Vsync) and so that all the LVDS video signals are received within a cycle period of the switching signal (L/R). It should be noted that the switching signal (L/R) and the synchronization signal (Vsync) may be supplied from a signal generator (not shown).

In this embodiment, since the sub-frame data is FHD image data, the output module 13 may include a transmission interface (not shown), which may be one of a universal asynchronous receiver/transmitter (UART) interface, an inter-integrated circuit (I2C) interface and a general-purpose input/output (GPIO) interface that can support transmission of FHD image data.

The display device 20 includes a timing control module 21 coupled to the output module 13 of the image processing device 10, and a display module 22 coupled to the timing control module 21.

The timing control module 21 receives the LVDS video signals from the output module 13 in accordance with the switching signal (L/R) and the synchronization signal (Vsync). In addition, the timing control module 21 may further receive a data enable signal, clock signals, horizontal/vertical synchronization signals (not shown) or the like for further operations. The timing control module 21 is operable to decode the LVDS video signals respectively into a plurality of video data, to process the plurality of video data in a manner that the plurality of video data is recombined together and optionally decompressed to become a single frame, i.e., recover the frame data of the digital image signal, so as to generate a display image signal, which corresponds to the frame data. The timing control module further generates a plurality of timing control signals based on the display image signal, the data enable signal and the horizontal/vertical synchronization signals. In this embodiment, the display image signal is a UHD image signal.

The display module 22 receives the display image signal and the timing control signals from the timing control module 21, and is controlled by the timing control signals to display the display image signal thereon. In this embodiment, the display module 22 may include a driving circuit unit and a pixel array (not shown). The driving circuit unit may receive the timing control signals and the display image signal from the timing control module 21 and generate a plurality of data and gate driving signals based on the timing control signals. The pixel array is driven by the data and gate driving signals to display the display image signal thereon.

It should be noted that the image processing device 10 and the display device 20 of this invention may be included respectively in two different electronic devices, for example, a set top box and a television. Alternately, the image processing device 10 and the display device 20 of this invention may be included in the same electronic device with image display functionality, for example, a smart phone, a television or the like.

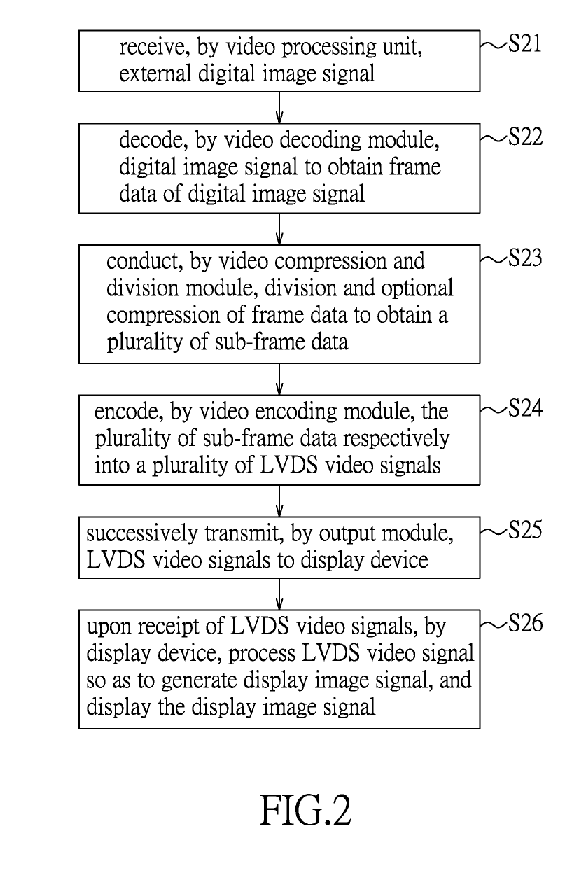

FIG. 2 is a flow chart illustrating the preferred embodiment of an image processing method according to the present invention implemented by the image display system of FIG. 1. To begin, referring again to FIG. 1, the video processing unit 12 receives an external digital image signal that includes at least one image frame through the input module 11 (step S21). Next, the video decoding module 121 decodes the digital image signal to obtain one frame data of the digital image signal (step S22). Next, the video compression and division module 122 compresses and divides the frame data into a plurality of sub-frame data, each of which corresponds to a respective portion of the image frame (step S23). It should be noted that, in step S23, the video compression and division module 122 may first compress the frame data along at least one of a vertical direction and a horizontal direction, and then divide the compressed frame data into the plurality of sub-frame data. Alternately, the video compression and division module 122 may first divide the frame data into a plurality of data blocks, and then compress the plurality of data blocks along at least one of the vertical direction and the horizontal direction respectively into the plurality of sub-frame data. Alternatively, the compress ion may be optional. Next, the video encoding module 123 encodes the plurality of sub-frame data respectively into a plurality of LVDS video signals (step S24). Next, the output module 13 successively transmits the LVDS video signals corresponding respectively to the plurality of sub-frame data to the display device 20 in accordance with a switching signal (L/R) and a synchronization signal (Vsync), so that each of the LVDS video signals is received within a cycle period of the synchronization signal (Vsync) and so that all the LVDS video signals are received within a cycle period of the switching signal (L/R) (step S25). Finally, upon receipt of the LVDS video signals from the output module 13 of the image processing device 10 in accordance with the switching signal (L/R) and the synchronization signal (Vsync), the display device 20 processes the LVDS video signals so as to generate a display image signal, which corresponds to the frame data and is displayed thereon (step S26). In this embodiment, in step S26, the LVDS video signals are encoded respectively into a plurality of video data that corresponds to the plurality of sub-frame data, and the plurality of video data is processed by the timing control module 21 of the display device 20 in a manner that the plurality of video data is recombined together and optionally decompressed to become a single frame, i.e., recover the frame data of the digital image signal.

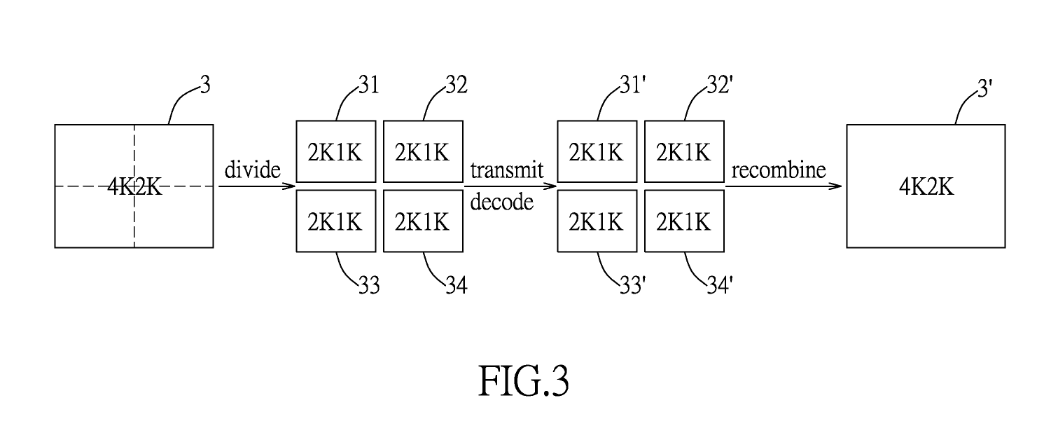

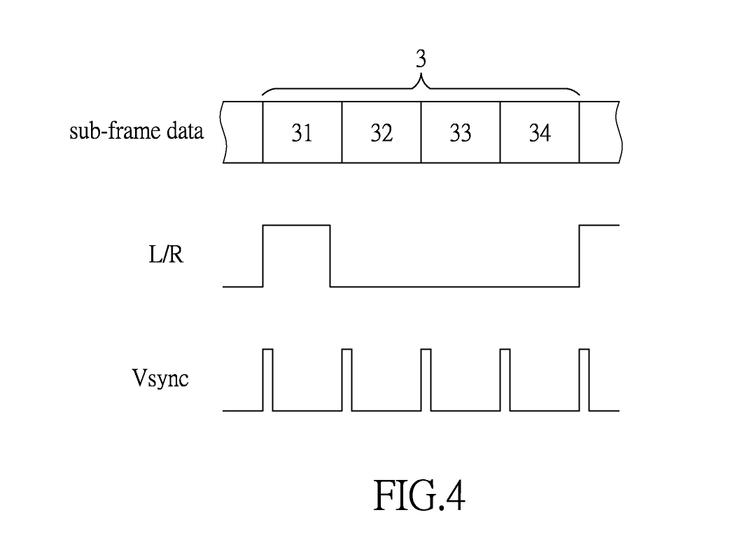

FIG. 3 shows an exemplary procedure illustrating how one frame data 3 of a digital image signal is processed according to a first embodiment of this invention. In the first embodiment, for example, the frame data 3 is UHD image data with 3840×2160 (4K2K as shown) resolution. The frame data 3 is directly divided into four sub-frame data, i.e., upper left sub-frame data 31, upper right sub-frame data 32, lower left sub-frame data 33 and lower right sub-frame data 34, along the vertical and horizontal directions without compression. Therefore, each sub-frame data 31, 32, 33, 34 is FHD image data with 1920×1080 (2K1K as shown) resolution. Next, referring further to FIGS. 1 and 4, the four sub-frame data 31, 32, 33, 34 in the form of LVDS video signals are successively transmitted to the display device 20 in accordance with the switching signal (L/R) and the synchronization signal (Vsync). It should be noted that the output module 13 is triggered at a rising edge of one pulse of the switching signal (L/R) to start transmission of the four sub-frame data 31, 32, 33, 34 and transmits the four sub-frame data 31, 32, 33, 34 respectively at rising edges of four consecutive pulses of the synchronization signal (Vsync). In the first embodiment, the cycle period of the switching signal (L/R) is four times the cycle period of the synchronization signal (Vsync). Next, the display device 20 obtains four video data 31′, 32′, 33′ 34′, which correspond to the four sub-frame data 31, 32, 33, 34, through decoding the LVDS video signals. Finally, the display device 20 recombines the four video data 31′, 32′, 33′, 34′ together to become a single frame 3′ with 4K2K resolution in away relative to the method adopted by the video processing unit 12 to divide the frame data 3 into the four sub-frame data 31, 32, 33, 34.

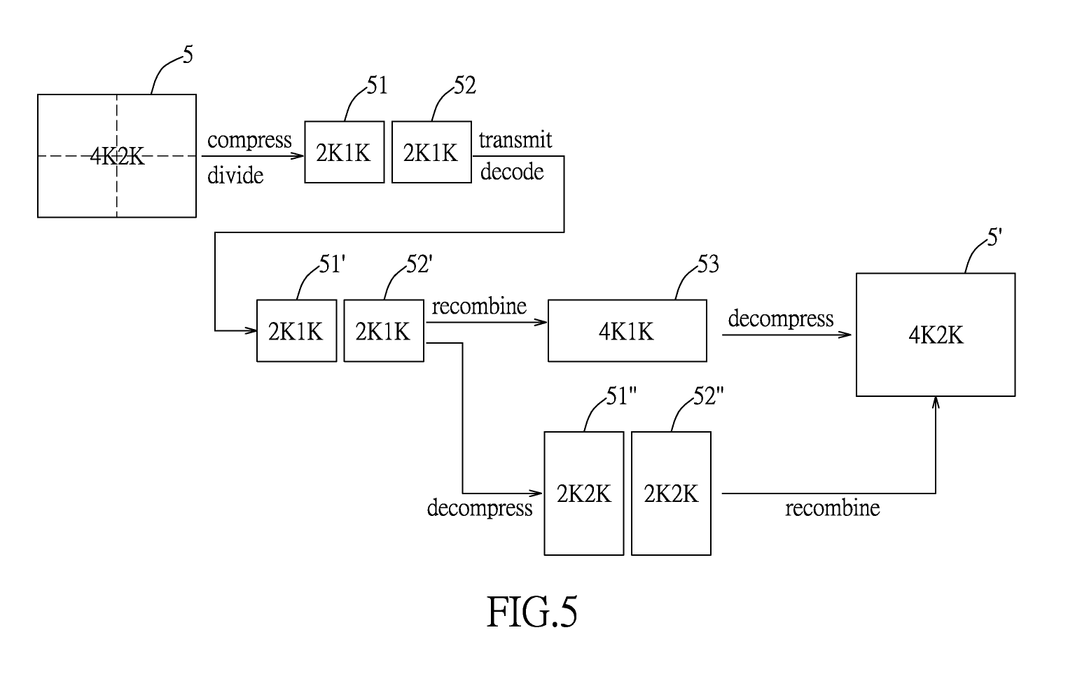

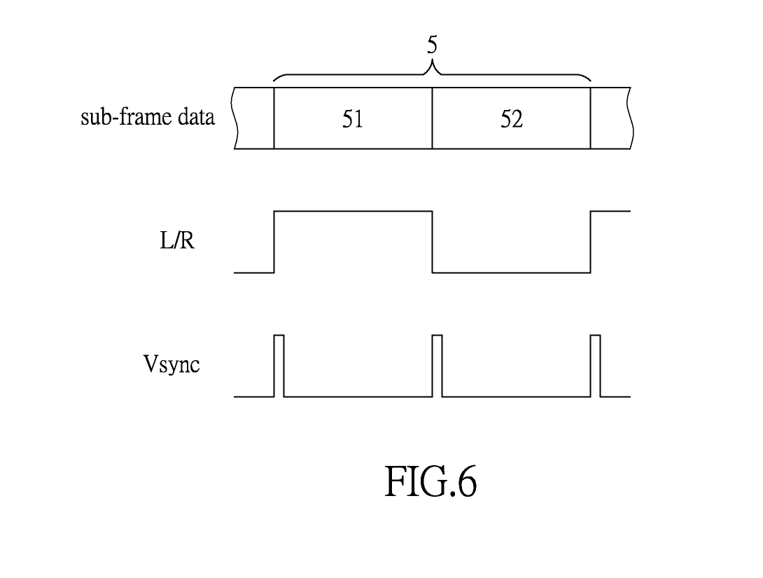

FIG. 5 shows another exemplary procedure illustrating how one frame data 5 of a digital image signal is processed according to a second embodiment of this invention. In the second embodiment, for example, the frame data 5 is UHD image data with 3840×2160 (4K2K as shown) resolution. The frame data 5 may be first compressed, i.e., resized, along the vertical direction and then divided along the horizontal direction into two sub-frame data, i.e. left sub-frame data 51 and right sub-frame data 52. Alternately, the frame data 5 may be first divided into two data blocks (not shown) along the horizontal direction, and the two data blocks may then be compressed along the vertical direction respectively into the two sub-frame data 51, 52. Therefore, each sub-frame data 51, 52 is FHD image data with 1920×1080 (2K1K as shown) resolution. Next, referring further to FIGS. 1 and 6, the two sub-frame data 51, 52 in the form of LVDS video signals are successively transmitted to the display device 20 in accordance with the switching signal (L/R) and the synchronization signal (Vsync). It should be noted that the output module 13 is triggered at a rising edge of one pulse of the switching signal (L/R) to start transmission of the two sub-frame data 51, 52 and transmits the two sub-frame data 51, 52 respectively at rising edges of two consecutive pulses of the synchronization signal (Vsync). In the second embodiment, the cycle period of the switching signal (L/R) is double the cycle period of the synchronization signal (Vsync). Next, the display device 20 obtains two video data 51′, 52′, which correspond to the two sub-frame data 51, 52, through decoding the LVDS video signals. Finally, the display device 20 may first recombine the two video data 51′, 52′ together along the horizontal direction to become an intra-frame 53 with 4K1K resolution, and the intra-frame 53 may then be decompressed along the vertical direction to become a single frame 5′ with 4K2K resolution. Alternately, the display device 20 may first decompress the two video data 51′, 52′ respectively into two decompressed video data 51″, 52″ with 2K2K resolution along the vertical direction, and the two decompressed video data 51″, 52″ may be then recombined together along the horizontal direction to become the single frame 5′.

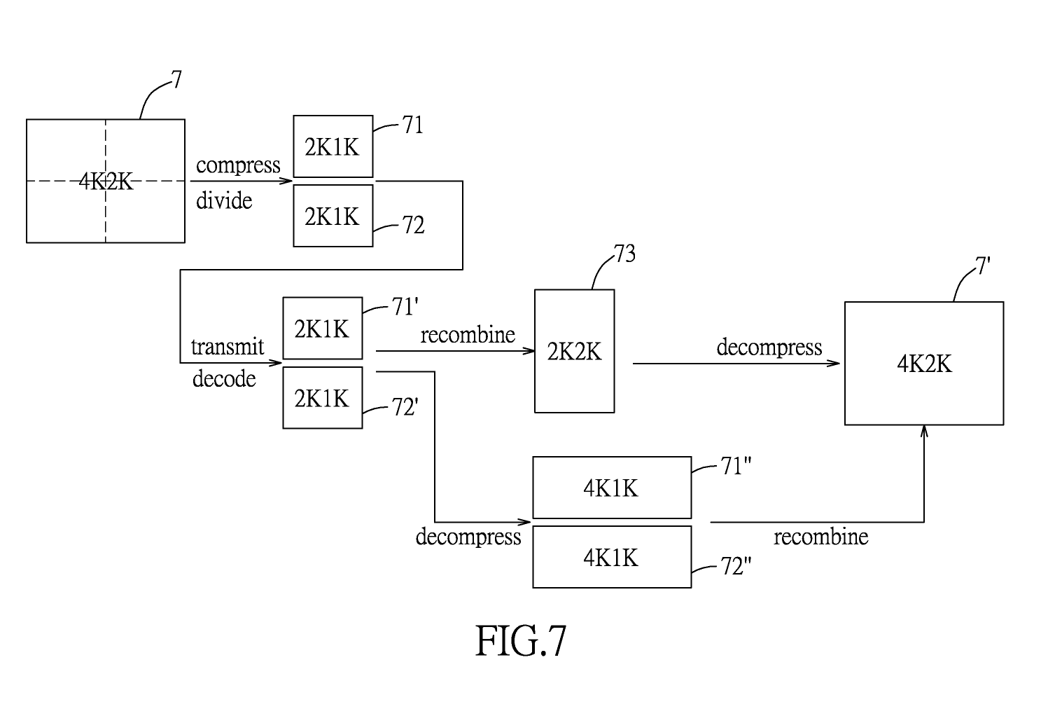

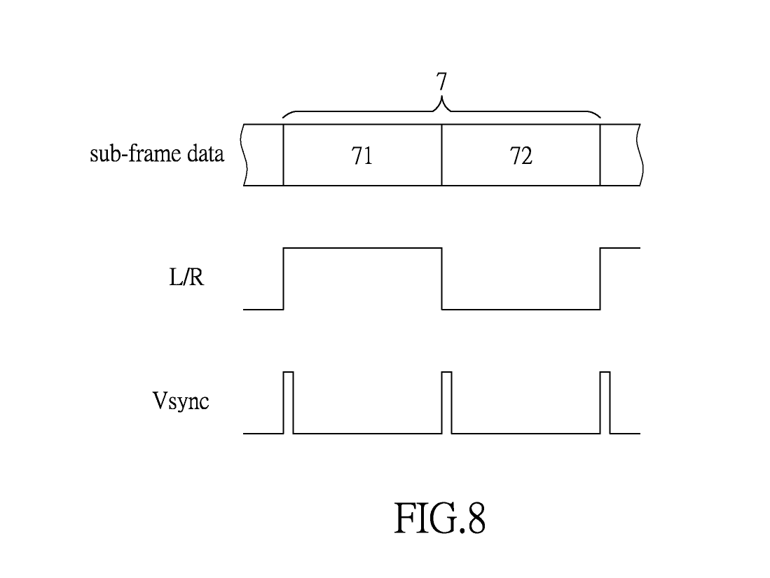

FIG. 7 is a further exemplary procedure illustrating how one frame data 7 of a digital image signal is processed according to a third embodiment of this invention. In the third embodiment, for example, the frame data 7 is UHD image data with 3840×2160 (4K2K as shown) resolution. The frame data 7 may be first compressed, i.e., resized, along the horizontal direction and then be divided along the vertical direction into two sub-frame data, i.e., upper sub-frame data 71 and lower sub-frame data 72. Alternately, the frame data 7 may be first divided into two data blocks (not shown) along the vertical direction, and the two data blocks may then be compressed respectively along the horizontal direction into the two sub-frame data 71, 72. Therefore, each sub-frame data 71, 72 is FHD image data with 1920×1080 (2K1K as shown) resolution. Next, referring further to FIGS. 1 and 8, the two sub-frame data 71, 72 in the form of LVDS video signals are successively transmitted to the display device 20 in accordance with the switching signal (L/R) and the synchronization signal (Vsync). It should be noted that the output module 13 is triggered at a rising edge of one pulse of the switching signal (L/R) to start transmission of the two sub-frame data 71, 72 and transmits the two sub-frame data 71, 72 respectively at rising edges of two consecutive pulses of the synchronization signal (Vsync). In the third embodiment, the cycle period of the switching signal (L/R) is double the cycle period of the synchronization signal (Vsync). Next, the display device 20 obtains two video data 71′, 72′, which correspond to the two sub-frame data 71, 72, through decoding the LVDS video signals. Finally, the display device 20 may first recombine the two video data 71′, 72′ together along the vertical direction to become an intra-frame 73 with 2K2K resolution, and the intra-frame 73 may then be decompressed along the horizontal direction to become a single frame 7′ with 4K2K resolution. Alternately, the display device 20 may first decompress the two video data 71′, 72′ respectively into two decompressed video data 71″, 72″ with 4K1K resolution along the horizontal direction, and the two decompressed video data 71″, 72″ may then be recombined together along the vertical direction to become the single frame 7′.

Via the image processing method as illustrated above, each UHD frame data of a digital image signal with a 30 Hz or 60 Hz frame rate maybe converted into a plurality of FHD sub-frame data, which is then transmitted to the display device 20 through the output module 13 having the FHD transmission interface supported by current DVD (BlueRay) players, computer devices or the like. Therefore, when the image processing device 10 and the display device 20 are used to implement the image processing method of this invention, there is no need to upgrade their transmission interfaces, and currently existing transmission interfaces may be utilized for transmission of the LVDS video signals therebetween. Thus, a UHD image signal with ultra high resolution can be transmitted by currently existing hardware devices. The cost required for upgrading the transmission interface can be greatly saved.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An image display system comprising:
a display device; and
an image processing device including
a video processing unit configured to receive an external digital image signal, which includes at least one image frame, said video processing unit including
a video decoding module for decoding the digital image signal to obtain one frame data of the digital image signal that corresponds to the image frame,
a video adjusting module for conducting division of the frame data to obtain a plurality of sub-frame data, each of which corresponds to a respective portion of the image frame, and
a video encoding module for encoding the plurality of sub-frame data respectively into a plurality of low-voltage differential signaling (LVDS) video signals, and
an output module coupled to said video processing unit and said display device, and successively transmitting the LVDS video signals from said video processing unit to said display device in accordance with a switching signal and a synchronization signal, so that each of the LVDS video signals is transmitted within a cycle period of the synchronization signal and so that all the LVDS video signals are transmitted within a cycle period of the switching signal;
wherein said display device receives the LVDS video signals from said output module of said image processing device in accordance with the switching signal and the synchronization signal, and processes the LVDS video signals so as to generate a display image signal, which corresponds to the frame data and is displayed thereon.

2. The image display system as claimed in claim 1, wherein said image processing device further includes an input module coupled to said video processing unit for transmitting the digital image signal thereto.

3. The image display system as claimed in claim 2, wherein said input module includes a transmission interface, which is one of a high-definition multimedia interface (HDMI), a display port (DP) interface, a digital interface for audio and video (DiiVA) and a thunderbolt interface.

4. The image display system as claimed in claim 1, wherein each of the plurality of sub-frame data is full high-definition (FHD) image data, and said output module includes a transmission interface capable of supporting transmission of FHD image data.

5. The image display system as claimed in claim 4, wherein said transmission interface is one of a universal asynchronous receiver/transmitter (UART) interface, an inter-integrated circuit (I2C) interface and a general-purpose input/output (GPIO) interface.

6. The image display system as claimed in claim 1, wherein the frame data is ultra high-definition (UHD) image data, and the display image signal is a UHD image signal.

7. The image display system as claimed in claim 1, wherein said video adjusting module further conducts compression prior to or subsequent to the division of the frame data so as to obtain the plurality of sub-frame data.

8. The image display system as claimed in claim 7, wherein said video adjusting module first compresses the frame data along at least one of a vertical direction and a horizontal direction, and then divides the compressed frame data into the plurality of sub-frame data.

9. The image display system as claimed in claim 7, wherein said video adjusting module first divides the frame data into a plurality of data blocks, and then compresses the plurality of data blocks along at least one of a vertical direction and a horizontal direction respectively into the plurality of sub-frame data.

10. The image display system as claimed in claim 7, wherein said display device includes:
a timing control module coupled to said output module of said image processing device for receiving the LVDS video signals therefrom, said timing control module being operable to decode the LVDS video signals respectively into a plurality of video data that correspond respectively to the plurality of sub-frame data, to process the plurality of video data in a manner that the plurality of video data is recombined together and decompressed to become a single frame so as to generate the display image signal, and to generate a plurality of timing control signals based on the display image signal; and
a display module coupled to said timing control module for receiving the display image signal and the timing control signals therefrom, and controlled by the timing control signals to display the display image signal thereon.

11. The image display system as claimed in claim 1, wherein said display device includes:
a timing control module coupled to said output module of said image processing device for receiving the LVDS video signals therefrom, said timing control module being operable to decode the LVDS video signals respectively into a plurality of video data that correspond respectively to the plurality of sub-frame data, to process the plurality of video data in a manner that the plurality of video data is recombined together to become a single frame so as to generate the display image signal, and to generate a plurality of timing control signals based on the display image signal; and
a display module coupled to said timing control module for receiving the display image signal and the timing control signals therefrom, and controlled by the timing control signals to display the display image signal thereon.

12. An image processing method comprising the steps of:
a) upon receipt of an external digital image signal including at least one image frame, decoding, by an image processing device, the digital image signal to obtain one frame data of the digital image signal that corresponds to the image frame;
b) conducting, by the image processing device, division of the frame data to obtain a plurality of sub-frame data, each of which corresponds to a respective portion of the image frame;
c) encoding, by the image processing device, the plurality of sub-frame data respectively into a plurality of low-voltage differential signaling (LVDS) video signals; and
d) successively transmitting, by the image processing device, the LVDS video signals to a display device in accordance with a switching signal and a synchronization signal; and
e) upon receipt of the LVDS video signals in accordance with the switching signal and the synchronization signal, by a display device, processing the LVDS video signals so as to generate a display image signal corresponding to the frame data, and displaying the display image signal.

13. The image processing method as claimed in claim 12, wherein each of the plurality of sub-frame data is full high-definition (FHD) image data.

14. The image processing method as claimed in claim 12, wherein the frame data is ultra high-definition (UHD) image data, and the display image signal is a UHD image signal.

15. The image processing method as claimed in claim 12, wherein, in step b), the image processing device further conducts compression prior to or subsequent to the division of the frame data so as to obtain the plurality of sub-frame data.

16. The image processing method as claimed in claim 15, wherein, in step b), the image processing device first compresses the frame data along at least one of a vertical direction and a horizontal direction, and then divides the compressed frame data into the plurality of sub-frame data.

17. The image display system as claimed in claim 15, wherein, in step b), the image processing device first divides the frame data into a plurality of data blocks, and then compresses the plurality of data blocks along at least one of a vertical direction and a horizontal direction respectively into the plurality of sub-frame data.

18. The image display system as claimed in claim 15, wherein, instep e), the LVDS video signals are decoded respectively into a plurality of video data that correspond respectively to the plurality of sub-frame data, and the plurality of video data is processed in a manner that the plurality of video data is recombined together and decompressed to become a single frame so as to generate the display image signal.

19. The image display system as claimed in claim 12, wherein, instep e), the LVDS video signals are decoded respectively into a plurality of video data that correspond respectively to the plurality of sub-frame data, and the plurality of video data is processed in a manner that the plurality of video data is recombined together to become a single frame so as to generate the display image signal.
